(19) United States
(12) Patent Application Publication
(10) Pub. No.: US 2025/0189498 A1
(43) Pub. Date: Jun. 12, 2025

(54) SYSTEM AND METHOD FOR AUTONOMOUS BOTANICAL IDENTIFICATION AND ADULTERATION DETECTION

(71) Applicant: Access Business Group International LLC, Ada, MI (US)

(72) Inventor: Nathan Patrick Stern, Grand Rapids, MI (US)

(21) Appl. No.: 18/535,346

(22) Filed: Dec. 11, 2023

(51) Int. Cl. G01N 30/95; G06N 3/0464

(52) U.S. Cl. CPC G01N 30/95; G06N 3/0464

(57) ABSTRACT

A system and method for automating the identification of botanicals and detection of adulterants based on High Performance Thin-Layer Chromatography (“HPTLC”) images. The system and method includes a first neural network that augments an existing HPTLC image dataset with synthetic data created using an adversarial machine learning model. For example, the synthetic data may be created using a generative adversarial network (GAN). The system and method further includes a second neural network that is trained on a combination of real data and synthetic data produced by the adversarial machine learning model. For example, the second neural network may be a deep convolutional neural network (CNN). Following training, the CNN performs the identification of botanicals and detection of adulteration through machine vision-based analysis of the output image data corresponding to phytochemical composition from HPTLC. The system may provide confidence-based probabilities and other numerical outputs related to the identify and adulteration determinations.

### FIELD OF THE INVENTION

The present invention relates to automated machine vision systems and methods, and more specifically to automated machine vision systems and methods for identifying botanicals and detecting adulteration in botanicals.

### BACKGROUND OF THE INVENTION

High-performance Thin-Layer Chromatography (“HPTLC”) is a chromatographic separation technique that is common and widely used for botanical identification and adulteration testing. Scientists trained in this approach use compendial or in-house test methods to generate image data that is visually examined in comparison to reference images from authentic botanicals and common adulterants to determine authenticity and to infer whether the botanical is adulterated. Scientists must be well-trained and rely on their best judgement to draw accurate conclusions. The current paradigm is dependent on the quality of the training the scientists receive as well as any inherent subjectivity and biases they may have. The quality associated with review by individual scientists may also be limited by the range and quality of reference images available to and remembered by the scientist. Further, the time required for a scientist to review and make a determination may be relatively slow and may vary from individual to individual based on the experience, memory and expertise of the scientist and from sample to sample depending on the complexity of the sample and its similarity to the set of reference images.

As a result of these and potentially other inherent issues, it has been recognized that improvements to conventional HPTLC techniques would be beneficial. Given that HPTLC involves the review of reference images, it might be feasible to implement an automated system with machine vision algorithms based on deep convolutional neural networks (“CNN”). However, machine visions systems that implement a CNN typically require large and extensive datasets, which are generally needed to provide proper training of the system. Unfortunately, existing HPTLC datasets are not sufficient in size or sufficiently extensive to provide adequate training for use in machine vision systems based on a CNN.

As a result, there remains a need for a system and method that allows automation of the review of HPTLC images to identify botanicals and detect adulteration.

### SUMMARY OF THE INVENTION

The present invention provides a system and method for automating the identification of botanical and detection of adulterants based on HPTLC using machine vision and artificial intelligence. The system and method includes a first neural network that augments existing HPTLC image data with synthetic data using an adversarial machine learning model. For example, the synthetic data may be created using a generative adversarial network (“GAN”) that is trained using a limited set of real HPTLC image data. The system and method further includes a second neural network that is trained on a combination of real HPTLC image data and synthetic data produced by the adversarial machine learning model. For example, the second neural network may be a deep convolutional neural network (“CNN”) that is trained on real and synthetic HPTLC image data. Following training, the CNN is capable of performing the identification of botanicals and detection of adulteration through machine vision-based analysis of new real HPTLC image data corresponding to phytochemical composition from High Performance Thin-Layer Chromatography. In one embodiment, the system is configured to provide confidence-based probabilities and possibly other numerical outputs related to the identify and adulteration determinations.

In one embodiment, the present invention provides a software system and accompanying interface that uses image data corresponding to phytochemical composition from High-performance Thin-Layer Chromatography (“HPTLC”) to determine the genus and species of plant material, and to provide a numerical representation of conformity and/or percent of adulteration.

In one embodiment, the system performs all necessary image transformations on real HPTLC image data provided to the system, and uses generative adversarial networks (“GAN”) to augment limited datasets for use in machine vision models.

In one embodiment, the system may use interpolation to create supplemental synthetic data that blends the image features of different species to mimic circumstances in which partial adulteration of target species has occurred.

In one embodiment, the identification and adulteration detection are performed using machine vision models based on deep convolutional neural networks (“CNN”), which are also designed to provide confidence-based probabilities and other numerical outputs related to the identity and adulteration determinations.

In one embodiment, a system in accordance with the present invention is configured to import individual raw image data files, or batches of files from different folders, for example, in .png format, and then automatically crop the images to remove extraneous or unnecessary portions of the image. The remaining images consist only of HPTLC phytochemical data that is saved, for example, in a separate, user designated file folder.

In one embodiment, the system converts the processed image files from .png format (or other format) into labeled tensor datasets, where the labels are designations that the system automatically applies to each image according to their respective genus/species. In this embodiment, a tensor may be a multi-dimensional array that contains the multi-channel pixel data for the images and the applied label(s). The multi-channel data may be the values from 0 to 255 for the red, green, and blue primary colors used to encode pixel data. The system allows for tensor datasets to be created for each individual species or for multiple species to be in a single tensor dataset. At this point the system will randomize and split the datasets into test and validation datasets. The test dataset will be used in the creation of the GAN and the validation dataset will be used to ensure that the GAN is functioning correctly and as designed.

In one embodiment, the software system uses a GAN to create synthetic data. The GAN may be a neural network architecture that uses two competing, iterative machine learning (ML) models. One ML model is designated as the generator, and the other as the discriminator. The generator is designed to create increasingly realistic synthetic data, while the discriminator is designed to constantly improve in distinguishing between real and synthetic data.

In one embodiment, the generator is configured to take random noise data as an input parameter. This noise is then sequentially transformed via deconvolutional methods from the Pytorch library to add features and is upscaled until it matches the dimensions of the real image files. In one embodiment, batch normalization and rectified linear unit activation occurs for each step of the sequence, and hyperbolic tangent activation occurs at the last, or output, stage of the sequence.

In one embodiment, the discriminator sequentially uses convolutional methods from the Pytorch library to extract features and downsample the images. In one embodiment, the discriminator also uses batch normalization and rectified linear unit activation for each step but does not use hyperbolic tangent activation.

In one embodiment, both the generator and discriminator are initialized with specific learning parameters to control the speed and efficiency of their ML models. These parameters values and weights will vary depending on how the competition between the two ML models proceeds.

In one embodiment, the system includes one or more Graphics Processing Unit(s) (GPU), which provide different processing functionality, such as Compute Unified Device Architecture (CUDA) cores and Tensor cores. The system may be designed to use both of these GPU features to improve efficiency and scalability.

In one embodiment, the system includes an interface that provides feedback on the learning process through visual outputs. The visual output may be provided at any specified frequency of generations (e.g., every n^{th} generation a visual output is produced). The visual output may include the resulting Binary Cross Entropy Loss (BCE-Loss) function result for both the generator and discriminator.

In one embodiment, the system is configured to save each machine learning (“ML”) model once a set number of generations is reached or the output images and loss functions are optimal. In this embodiment, the ML models are then tested against the validation dataset. Once validation is complete and is successful, the ML models are used to generate and save any specified number of synthetic images.

In one embodiment, the system uses interpolative algorithms on the finalized dataset to create a gradient of hybridizations between specific plant species and their adulterants. This results in supplemental synthetic image data that contains increasing amounts of the phytochemical composition of each adulterant, which can then be used as an intermediate ML class between authentic and adulterant species. When implemented, the resulting output of this interpolation-based feature blending is another large dataset of synthetic images that are representative of how an adulterated botanical appears while performing HPTLC testing. This further augments the dataset by accounting for instances when an authentic sample (e.g. ginger) has been added to or spiked with increasing amounts inauthentic adulterants (e.g. non-ginger materials). This additional dataset can be added to a specific species class as previously made by the GAN generator or as a separate class.

In one embodiment, the synthetic images are combined with the real images for each genus/species. In this embodiment, the system uses this mixed dataset to create and train a deep CNN, which functions as a tool for determining taxonomic identity of plants and for detecting the presence of adulterants in a target sample based on real word HPTLC images from that target sample. In an alternative embodiment, the real and synthetic datasets may be kept separate, and the real dataset may be used to carry out an additional validation step. For example, in one implementation of this alternative embodiment, the synthetic data is split into training and validation datasets that are used to train and perform an initial validation of the CNN, and the real data is used to perform a second validation of the CNN. In other alternative embodiments, the real and synthetic datasets may be combined or used separately in other ways.

In one embodiment, the system is designed to use either any number of individual, species specific classification ML models or a single, large multiple-class classification model. Either approach can be used to create a deep CNN-based system that has been trained on any number of plant species and adulterants.

In one embodiment, the system uses a deep CNN to create a discriminative ML model(s) that is designed to take input from raw HPTLC image data and output genus/species classification conformity as well as report an amount of adulteration, if detected. In one embodiment, the CNN sequentially uses convolutional methods from Pytorch library to extract features and downsample the images. In one embodiment, every step except for the final step of the sequence also includes batch normalization, rectified linear unit activation, and dropout. The final step of the sequence instead uses adaptive average pooling, flattening, and softmax activation.

In one embodiment, during the learning process, the CNN is initialized with specific learning parameters to control the learning process and to prevent issues such as overfitting or mode collapse. The system may be designed to iterate through either a specified number of generations or to continue until a stop command is given. As with the GAN, the CNN in the system may be designed to use a modern GPU that has CUDA and Tensor cores.

In one embodiment, the system includes an interface that is designed to provide feedback while the system is learning from the test dataset. The output of the interface may include results from a Cross Entropy Loss function. The system may be designed to save the CNN model once a set number of generations is reached or the loss functions are optimal.

In one embodiment, the system tests the saved CNN ML model against the validation dataset(s) and outputs the conformity and adulteration results for the dataset.

In one embodiment, the system uses the successfully validated CNN ML model to automatically pre-process new raw data in the same manner as described for the GAN and then apply the learned deep CNN against it. The system may then output via the interface the results for the determined genus/species, the % conformity to the determined genus/species, and the amount of adulteration that is detected.

In one embodiment, the system uses a single large database of images from any species or interpolated class based on any adulterants. This large database is used to train and validate a correspondingly large and more complex version of the proposed system, such that any new unknown sample is evaluated against any target species/class within the entire database. This type of implementation of the system is advantageous for any unknown samples, where the analysis is untargeted to a specific set of species or adulterants. For instance, an unknown sample is tested by HPTLC and generates an image that is passed through the large database-based CNN, which then uses its ML algorithms to determine which of hundreds or more species or classes best matches the unknown sample's HPTLC image.

In one embodiment, the system uses one or more mini-database structures, where each mini-database of images is selected for a target species and its related species or known adulterants. This implementation is designed to be used when the target species is known and has the advantage of being faster and more streamlined for routine use. For instance, a presupposed ginger sample is tested by HPTLC and generates an image that is passed through a mini-database-based CNN, which then uses its ML algorithms to determine which of several species or classes best matches the potential ginger sample's HPTLC image and if any adulteration is detected.

The present invention provides an effective and accurate HPTLC image-based machine-vision system and method for the identification of botanicals and adulterants. The use of a machine-vision system for botanical identification removes subjectivity inherent to human-based evaluation. The learned model can also accurately evaluate botanical HPTLC images significantly faster than its human counterpart, which could save both time and resources. The use of a generative adversarial neural network to create synthetic data greatly expands the training dataset available for training the neural network used to perform identification of botanicals and detection of adulterants. This eliminates the need to physically generate voluminous amounts of real data, saving time and resources.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an HPTLC raw image.

FIG. 2A shows an HPTLC image after being processed in accordance with an embodiment of the present invention.

FIG. 2B shows cropped, native HPTLC fingerprint images for ginger and various common adulterants/related species.

FIG. 3 shows a representative sample of synthetic and real data output from a GAN implemented in accordance with an embodiment of the present invention.

FIG. 4A is a representation of a first output showing identity and adulteration results.

FIG. 4B is a representation of a second output showing identity and adulteration results.

FIG. 5 is a flowchart showing a system in accordance with an embodiment of the present invention.

FIG. 6 is a schematic representation showing functional blocks of an embodiment of the present invention.

FIG. 7 is a diagram showing the generalized architecture of the CNN used in creating the learned machine-vision model in an embodiment of the present invention.

### DESCRIPTION OF THE CURRENT EMBODIMENT

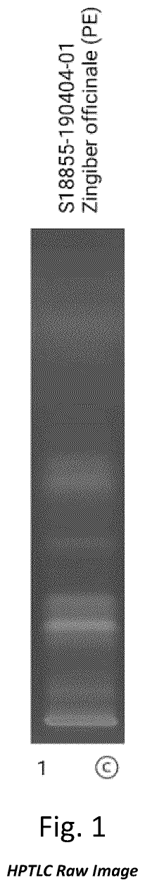

A botanical identification and adulteration detection system in accordance with an embodiment of the present invention is shown in FIGS. 1-7 and generally designated 10. The system 10 includes hardware and software systems that are configured to use machine learning to provide automated review of High-performance Thin-Layer Chromatography (“HPTLC”) images to identify botanical material and detect adulterants. There is a limited volume of real HPTLC image data and the system 10 is configured to operate despite the relatively small volume of available data. The system 10 of the illustrated embodiment generally includes a generative adversarial network (“GAN”) 12 and a convolutional neural network (“CNN”) 14. The GAN is configured to use a volume of real HPTLC image data to train a GAN machine learning model and to use the trained GAN machine learning model to generate a supplemental volume of synthetic HPTLC data. In this embodiment, the CNN is configured to use the limited volume of real HPTLC image data and/or the supplemental volume of synthetic HPTLC data to train a CNN machine learning model and to use the trained CNN machine learning model to review new HPTLC images to identify the represented botanicals and detect represented adulterants. For example, the system may be configured to determine and provide the genus and species of plant material, and to provide a numerical representation of conformity and/or percent of adulteration. The system may include a user interface that provides an output of the identified botanicals and detected adulterants, and may also include associated confidence-based probabilities and other numerical outputs related to the botanical and adulteration determinations.

Before describing exemplary embodiments of systems and methods in accordance with various aspects of the present disclosure, it should generally be understood that the systems and methods of the present disclosure can include and can be implemented on or in connection with one or more computers, microcontrollers, microprocessors, and/or other programmable electronics that are programmed to carry out the functions described herein. The systems may additionally or alternatively include other electronic components that are programmed to carry out the functions described herein, or that support the computers, microcontrollers, microprocessors, and/or other electronics. The other electronic components can include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in another manner, whether combined into a single unit or distributed across multiple units. Such components may be physically distributed in different positions in an embedded system, such as an image capture system, or they may reside in a common location. The artificial intelligence or machine learning models and supporting functionality can be integrated into electronic components that work in concert with an image capture system. In some embodiments, the GAN and/or CNN systems can be provided on a general purpose computer, special purpose computing components (such as GPUs) and/or within a dedicated hardware framework. When physically distributed, the components may communicate using any suitable serial or parallel communication protocol, such as, but not limited to SCI, WiFi, Bluetooth, FireWire, I2C, RS-232, RS-485, and Universal Serial Bus (USB).

The present invention will now be described in more detail with reference to FIGS. 1-5. As noted above, the present invention may be implemented as a software system implemented in appropriate hardware (as discussed elsewhere herein) with an accompanying user interface that uses the output image data corresponding to phytochemical composition from High-performance Thin-Layer Chromatography (“HPTLC”) to determine the genus and species of plant material, and, in this embodiment, to provide a numerical representation of conformity and/or percent of adulteration. For example, FIG. 1 is an exemplary HPTLC raw image, which shows the color bands that result from the HPTLC process.

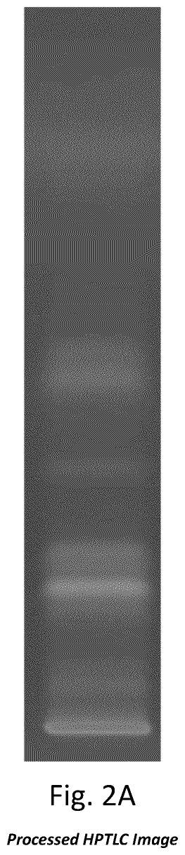

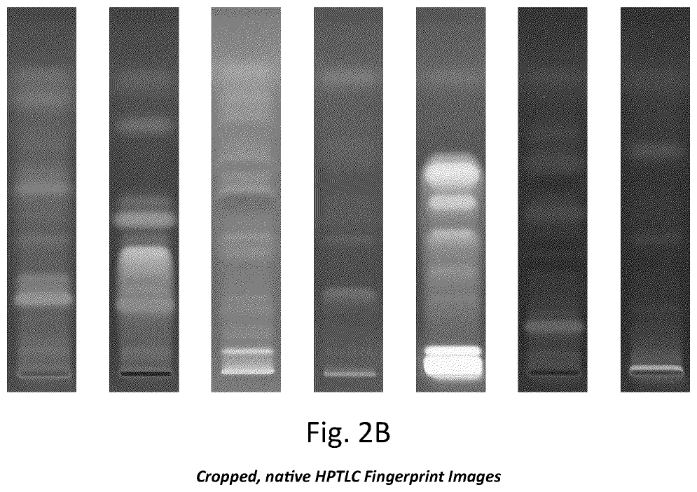

In the illustrated embodiment, the system 10 is configured to receive raw images that are not necessarily uniform and may benefit from one or more image processing steps that provide uniformity and/or transform, adapt or otherwise modify the images in preparation for use by the system 10. In this embodiment, the system 10 includes an image processing component that performs all necessary image transformations and uses generative adversarial networks (“GAN”) to augment limited datasets for use in machine vision algorithms. FIGS. 2A and 2B show processed HPTLC images. In the illustrated embodiment, the system also includes an interpolation component that uses interpolation methods to create synthetic data that blends the image features of different species to mimic circumstances in which partial adulteration of target species has occurred. In this embodiment, the interpolation may be implemented to create synthetic data that blends a range of specific proportions of adulterant features with a target species. This range may be a gradient from a trace amount of features up to nearly all features of the adulterant that have been added to the target species. In alternative applications, the system 10 may be implemented without an interpolation component. The identification and adulteration detection are performed using machine vision models based on deep convolutional neural networks (“CNN”), which are also designed to provide confidence-based probabilities and other numerical outputs related to the identity and adulteration determinations.

Expanding on the foregoing, experience has revealed that existing HPTLC datasets are not sufficient in size to be used in conventional machine vision applications, such as CNNs. More specifically, available real HPTLC datasets are not of sufficient volume and/or of sufficient breadth to provide adequate training of a deep CNN capable of effectively performing botanical identification and adulterant detection. In one aspect, the system 10 is designed to augment existing real HPTLC data with synthetic data that is created via a GAN machine learning model as further discussed herein. In alternative applications, synthetic data may be generated using other automated systems, such as variational autoencoders, auto-regressive models, transformer models, diffusion models, deep belief networks and conditional variational autoencoders.

In the illustrated embodiment, the system 10 is configured to receive raw HPTLC images, such as the image shown in FIG. 1. In this embodiment, the system 10 includes an image processing component that is configured to convert raw image files of HPTLC output into a format appropriate for use with the system 10. The type of image processing implemented on the captured images may vary from application to application depending in part on the method and manner of capturing images and the specifics of the GAN machine learning model. For example, in the illustrated embodiment, the image processing component of the system 10 imports individual raw image data files (See FIG. 1), or batches of files from different folders, in .png format, and then automatically crops the images to remove extraneous or unnecessary portions of the image (See FIG. 2A). The image processing component may be configured to implement any desirable image processing steps based on the nature of the raw image files and the requirements of the system 10, such as resizing/rescaling, cropping or padding, normalization, color space conversion, filtering and denoising, histogram equalization, channel standardization and/or processing of missing data. It should be understood that the present invention is not limited to use with .png file and that the system 10 may be configured to process raw image data files in essentially any image file format. After cropping, the remaining image consists only of HPTLC phytochemical data, which, in this embodiment, is saved in a separate, user designated file folder. In the context of a system directed to use with ginger, FIG. 2B shows cropped, native fingerprint images for, from left to right, Zingiber officinale, Alpinia officinarum, Boesenbergia rotunda, Kaempferia galanga, Kaempferia parviflora, Zingiber montanum, & Zingiber zerumbet. The choice of genus/species to incorporate into a specific embodiment of the present invention may vary from application to application as discussed in more detail below.

In the illustrated embodiment, the system 10 is configured to convert the files from the native format (e.g., .png format in this example) into a numerical tensor, which is a multidimensional array encoding the pixel height/width data and the pixel RGB color channel data. These tensors are each labeled automatically labeled by the system via the native image file nomenclature, which is parsed out to include metadata such as genus/species classifications. The aggregate of all of the tensors and their respective species labels are combined into a single data structure named a tensor dataset. In this embodiment, the automated process of processing images into labeled tensors and combining them into a tensor dataset is designed to allow for scalability and consistency for tensor datasets containing any number of species and corresponding labels. In the illustrated embodiment, the numerical tensor is a multi-dimensional array that has two spatial dimensions for the pixels (height and width) and a third dimension representing the RGB color values for each pixel. The multi-channel RGB color data may be values from 0 to 255 for the red, green, and blue primary colors used to encode pixel data. The system allows for tensor datasets to be created for each individual species or for multiple species to be in a single tensor dataset. In the illustrated embodiment, the process image files may be converted to a tensor dataset using a convention machine learning library, such as through the use of torchvision.transforms in the PyTorch open-source machine learning library.

At this point the system 10 will randomize and split the tensor datasets into test and validation datasets. The test dataset will be used in the creation of the GAN and the validation dataset will be used to ensure that the GAN is functioning correctly and as designed. The sizes of the test dataset and the validation dataset may vary from application to application, but, for example, the test dataset may include 80% of the tensor datasets and the validation dataset may include the remaining 20% of the tensor datasets.

In the illustrated embodiment, the system 10 uses a GAN to create synthetic data that will be used to supplement the tensor datasets, which were generated from real HPTLC image files. In this embodiment, the GAN (or GAN component) is a neural network architecture that uses two competing, iterative machine learning (ML) models. One ML model (or HPTLC GAN generator ML model) is designated as the generator, and the other (or HPTLC GAN discriminator ML model) as the discriminator. Through a GAN training component, the generator is designed to create increasingly realistic synthetic data, while the discriminator is designed to constantly improve in distinguishing between real and synthetic data. The system uses a generator (or noise generator component) that is designed to take random noise data the system creates as an input parameter. This noise is then sequentially transformed via deconvolutional methods from the Pytorch library to add features and is upscaled until it matches the dimensions of the real image files. Batch normalization and rectified linear unit activation occurs for each step of the sequence, and hyperbolic tangent activation occurs at the last, or output, stage of the sequence. The discriminator sequentially uses convolutional methods from the Pytorch library to extract features and downsample the images. The discriminator also uses batch normalization and rectified linear unit activation for each step but does not use hyperbolic tangent activation. Both the generator and discriminator are initialized with specific learning parameters to control the speed and efficiency of their ML models. These parameters values and weights will vary depending on how the competition between the two ML models proceeds. The learning parameters for GANs are often optimized by trial and error. However, some AI libraries provide “optimizers” that can work to tweak learning rate and potentially other parameters during the model's iterative learning. For example, the Pytorch library includes an optimizer (i.e. “Adam Optimizer”) that may be used to optimize learning parameters. Although the learning parameters may vary from application to application, some examples of common learning parameters that may be initialized for a GAN are:
Learning rate: The learning rate generally determines the “step size”, or how much change the model can make in learning, between each epoch. In this embodiment, the discriminator and the generator each have their own learning rate, and the goal is to set the learning parameters to optimize each to achieve balanced learning between the two. Having one of the models in the GAN outperform the other can cause one to “win” before optimal images can be achieved (similar to mode collapse, the discriminator and generator stop learning). Normally this value is between 0.0001 and 0.001, and if one model in the GAN is outperforming the other then each can be lowered and raised as needed.
Epoch number: The epoch number specifies how many generations the model will iterate through. In this embodiment, higher epoch numbers (10 k to 15 k) generally achieved best results. Too low of a number may result in poor images, and too high of a number may result in either mode collapse or overfitting.
Size of the noise vector: This parameter impacts the diversity and quality of generated images. A 1-dimensional vector of 100 nodes was implemented in the illustrated embodiment. Generally, a higher value is normally better because the model has more parameters to initially modify, but can lead to increased chance of mode collapse since it makes training initially much more complex.
Neural network weights: Neural network weights are factors that change input data into output data for each node-to-node connection in the entire neural network. Learning is generally achieved by adjusting the weight for each node connection after each epoch. The values here are typically initialized using a gaussian distribution of 0.0 and a standard deviation of 0.02 (these are typical for GANs). This means the weights are randomized, but that the randomness is controlled by the distribution mean and standard deviation so that training is more stable from the very first epoch.
Label smoothing: Smoothing factors generally adjust discriminator loss function calculations to address overfitting and mode collapse (from a model becoming overconfident). In the illustrated embodiment, a factor of 0.1 was applied to the loss function for synthetic images and 0.9 for the loss function for real images.
Batch size: The batch size is the number of training samples to be used per epoch. In the illustrated embodiment, 256 was used as the batch size. This parameter may affect speed and stability of training.

The preceding list of parameters is merely exemplary. Other learning parameters are discussed elsewhere herein (e.g. ReLU, batch normalization, loss function, etc.). Further, some available parameters were not used in the illustrated embodiment either because they were ineffective or not necessary for this context. Alternative applications may include other learning parameters, for example, depending on the AI library used to implement the system.

The goal for this portion of the GAN training component is to have balance between the discriminator and the generator's learning, so that one does not greatly outperform the other. The competitive learning process implemented through the GAN training component is iterative, with each generation for each of the two ML models designed to improve over the last. The GAN component is designed to iterate through either a set number of generations or to continue until a stop command is given. Although the configurations of the GAN generator ML model and the GAN discriminator ML model can vary from one implementation to another, in the illustrated embodiment, the GAN generator ML model includes input nodes that represent a simple noise vector that is upsampled via the learned model into an image that corresponds in size with the images in the tensor dataset (e.g. 128×128×3). While this means the number of nodes can be arbitrary, the illustrated embodiment includes a 1-dimensional vector of 100 nodes. While the input nodes of the GAN discriminator ML model can also vary, the input nodes in the illustrated embodiment of the GAN discriminator ML model are the entire image tensor itself, with each individual pixel's multidimensional array serving as part of the total input.

To facilitate faster computation and increase the frequency of the iterations over time, the system 10 of the illustrated embodiment is designed to use a Graphics Processing Unit (“GPU”). Modern GPUs come with different processing functionality, including Compute Unified Device Architecture (“CUDA”) cores and Tensor cores. CUDA cores excel at parallel processing tasks where the computations are simple, and tensor cores are designed to handle matrix multiplication and accumulation tasks that are common to deep ML models. The system 10 is configured to use both GPU features to improve both efficiency and scalability.

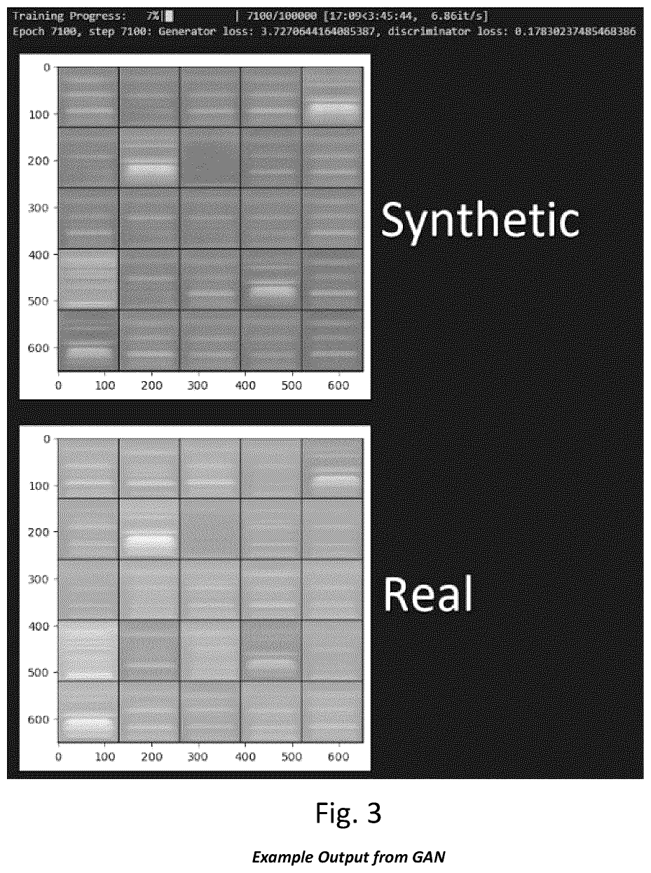

In the illustrated embodiment, the system 10 is configured to provide visual feedback on the learning process through visual outputs while the system's iteration is occurring. By way of example, FIG. 3 shows the output for one iteration in the illustrated. The visual output may be generated for any specified frequency of generations (e.g., every n^{th} generation a visual output is produced). As shown, the output may include the Binary Cross Entropy Loss (“BCE-Loss”) function results for both the generator and discriminator. The BCE-Loss function results are designed to be interpreted as how well each respective ML model is performing, and this information is used to ensure optimal balance between the discriminator and generator. Once the set number of generations is reached or the output images and loss functions are optimal, the system is designed to save each ML model so that they can be tested against the validation dataset. In this embodiment, the GAN component may include a GAN validation component configured to evaluate the ability of the HPTLC GAN generator machine learning model and the HPTLC GAN discriminator ML model to generate synthetic data. In this embodiment, the validation is performed by evaluating synthetic data against the GAN validation dataset. In some alternative embodiments, the step of separately validating one or both of the GAN machine learning models may be eliminated. For example, in some applications, validation of both GAN machine learning models can be skipped when validation of the CNN machine learning model is sufficient for validating the entire system.

Once validation is complete and is successful, the models are used to generate and save any specified number of synthetic images. For example, if the system is being designed to generate images for the eventual authentication of Zingiber officinale (i.e., common name: ginger) then it will have been trained and validated to generate tens of thousands or more synthetic images of both the target species and of each potential adulterant or closely related species (though the specific number of synthetic images may vary from application to application). With regard to ginger, the adulterants and closely related species may include, without limitation, Alpinia officinarum, Boesenbergia rotunda, Kaempferia galanga, Kaempferia parviflora, Zingiber montanum and Zingiber zerumbet. The system 10 can also use interpolative algorithms on the finalized model to create a gradient of hybridizations between specific plant species and their adulterants. This results in synthetic image data that contains increasing amounts of the phytochemical composition of each adulterant, which can then be used as an intermediate ML class between authentic and adulterant species. For example, the system 10 may include an interpolative component that is capable of generating new synthetic datasets with data that lies between two known points in the latent space. Using ginger again as an example, this means the system can blend the visual features of ginger HPTLC images with that of any closely related species, adulterant species, or adulterant chemical compounds. The scale by which this feature blending occurs is not static in the illustrated embodiment, but rather on a gradually increasing scale, meaning the synthetic images generated through this process start from adding only a few features of the chosen non-ginger dataset to adding nearly all the features from the same non-ginger dataset. The resulting output of this interpolation-based feature blending is another large dataset of synthetic images that are representative of how an adulterated ginger appears while performing HPTLC testing. This further augments the dataset by accounting for instances when authentic ginger has been added to or spiked with increasing amounts non-ginger materials to adulterate it. This additional dataset can be added to a specific species class as previously made by the GAN generator or as a separate class. The system is designed to automatically perform this feature blending procedure based on user-designated inputs. By way of example, the interpolation component may, in some applications, be implemented in PyTorch using one or more of the various functions provided in torch.nn.functional modules or using specific layers from the torch.nn module. The choice of function or layer will be selected based on the type of interpolation to be implemented, such as nearest, linear, bilinear, bicubic and trilinear.

Once a sufficient number of synthetic image datasets are created, they may be combined with the real image datasets for each genus/species. In the illustrated embodiment, the system 10 is designed to use this mixed real/synthetic dataset to create and train a deep CNN, which then functions as a tool for determining taxonomic identity of plants and for detecting the presence of adulterants. In alternative embodiments, the real and synthetic image datasets may be kept separate, and the real image dataset may be used to carry out an additional validation step. For example, in one implementation of this alternative embodiment, the synthetic image data is split into training and validation datasets that are used to train and perform an initial validation of the CNN, and the real image dataset is used to perform a second validation of the CNN. In other alternative embodiments, the real and synthetic datasets may be combined or used separately in other ways. The system 10 is designed to use either any number of individual, species specific classification ML models or a single, large multiple-class classification model. Either approach can be used to create a deep CNN-based system that has been trained on any number of plant species and adulterants.

The system 10 can perform data augmentation approaches, such as one or more random image transformations: rotation, translation, dilation, and/or reflection. Data augmentation techniques along with the GAN-generated synthetic images are used to improve the robustness of the CNN given that HPTLC techniques are often generalized, and the resulting image data is subject to variation. The system 10 will randomize and split the resulting, augmented datasets into test and validation datasets. The test dataset will be used in the creation of the CNN and the validation dataset will be used to ensure that the CNN is functioning correctly and as designed.

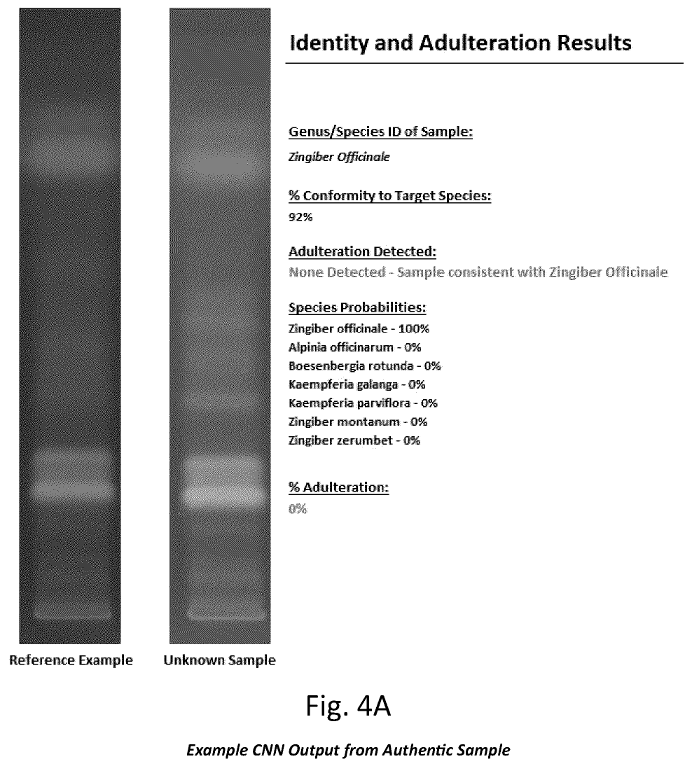

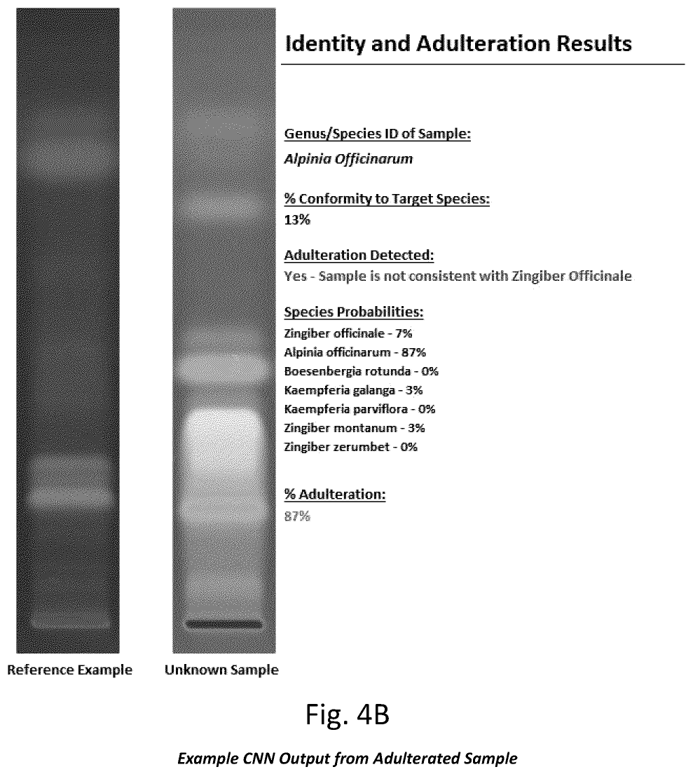

The system 10 of the illustrated embodiment uses a deep CNN to create a discriminative ML model(s) that is designed to take input from raw HPTLC image data and output genus/species classification conformity as well as report an amount of adulteration, if detected. In this embodiment, the deep CNN is generally implemented as a CNN training component and a CNN processing component. The structure of a CNN is like that of the discriminator in a GAN, but typically with greater complexity and more neural network layers. The CNN sequentially uses convolutional methods from Pytorch library to extract features and downsample the images. In the illustrated embodiment, every step except for the final step of the sequence also includes batch normalization, rectified linear unit activation, and dropout. In this embodiment, the final step of the sequence instead uses adaptive average pooling, flattening, and softmax activation. The CNN training component of the illustrated embodiment is initialized with specific learning parameters to control the learning process and to prevent issues such as overfitting or mode collapse. Many of the learning parameters discussed above in connection with the GAN component are relevant to the CNN component. For example, some of the more relevant GAN learning parameters set in connection with the illustrated embodiment are as follows:
Learning rate: For the CNN, there is only one rate needed as opposed to two by GAN, and optimization is geared more toward finding convergence quickly and avoiding local minima. Generally, optimization is much quicker and based more on success of model during validation. Typically, too low of a value and the model doesn't converge at the global minima and therefore may not make accurate predictions for all species. Too high and the model may miss both local and global minima altogether and may not make accurate predictions for any species.
Number of epochs: In the illustrated embodiment, the number of epochs used with the CNN is generally smaller than the GAN because convergence was more easily reached (25 epochs is sufficient when the dataset is as large/diverse as that used with the illustrated embodiment).
Neural network weights: In the illustrated embodiment, the Pytorch default values were used because the dataset was relatively simple, and convergence was reached without custom values being needed.
Batch size: The batch size was set using the same logic as with GAN, but a lower batch size was used in the illustrated embodiment to improve training speed.
   The CNN training component is designed to iterate through either a specified number of generations or to continue until a stop command is given. As with the GAN, the CNN in the system is designed to use a modern GPU that has CUDA and Tensor cores. While the system 10 is learning from the test dataset, it is designed to provide feedback via results from a Cross Entropy Loss function. Once the set number of generations is reached or the output images and loss functions are optimal, the system is designed to save the CNN model (or HPTLC CNN machine learning model). The system 10 then tests the saved HPTLC CNN machine learning model against the validation dataset, for example, with a CNN validation component, and outputs the conformity and adulteration results for the dataset. After successful validation, the CNN is ready for use in evaluating new HPTLC images. The validated CNN component can automatically pre-process new raw data (e.g. new HPTLC image data) in the same manner as described for the GAN and then apply the learned deep CNN against it. In the illustrated embodiment, the system 10 will then output the results for the determined genus/species, the % conformity to the determined genus/species, and the amount of adulteration that is detected (FIGS. 4A & FIG. 4B). Using ginger HPTLC images as an example, the “sample consistent with target species” designation will be applied by the system to new data in the event its Zingiber offinicale probability exceeds a user designated threshold (e.g., greater than 90%). If this threshold is not exceeded, the system 10 is designed to label the new image as “Not consistent with the target species”. For both cases, the system will output each of the species or class probabilities possible based on the target species chosen, as well as the percent adulteration detected. These aforementioned probabilities can either be attributed to individual species or to interpolation-based intermediate classes. As previously described, the classes can be formed via feature blending from adulterant species, closely related species, or adulterant chemical compounds.

The system allows for two different approaches to functionality. One approach uses a single large database of images from any species or interpolated class based on any adulterants. This large database is used to train and validate a correspondingly large and more complex version of the proposed system, such that any new unknown sample is evaluated against any target species/class within the entire database. This type of implementation of the system is advantageous for any unknown samples, where the analysis is untargeted to a specific set of species or adulterants. For instance, an unknown sample is tested by HPTLC and generates an image that is passed through the large database-based CNN, which then uses its ML model to determine which of hundreds or more species or classes best matches the unknown sample's HPTLC image.

As an alternative to using a large, extensive database covering a wide range of species, the system may use one or more mini-database structures, where each mini-database of images is selected for a targeted species and its related species or known adulterants. This implementation is designed to be used when the target species is known and has the advantage of being faster and more streamlined for routine use. For instance, a presupposed ginger sample is tested by HPTLC and generates an image that is passed through a mini-database-based CNN, which then uses its ML model to determine which of several species or classes best matches the potential ginger sample's HPTLC image and if any adulteration is detected.

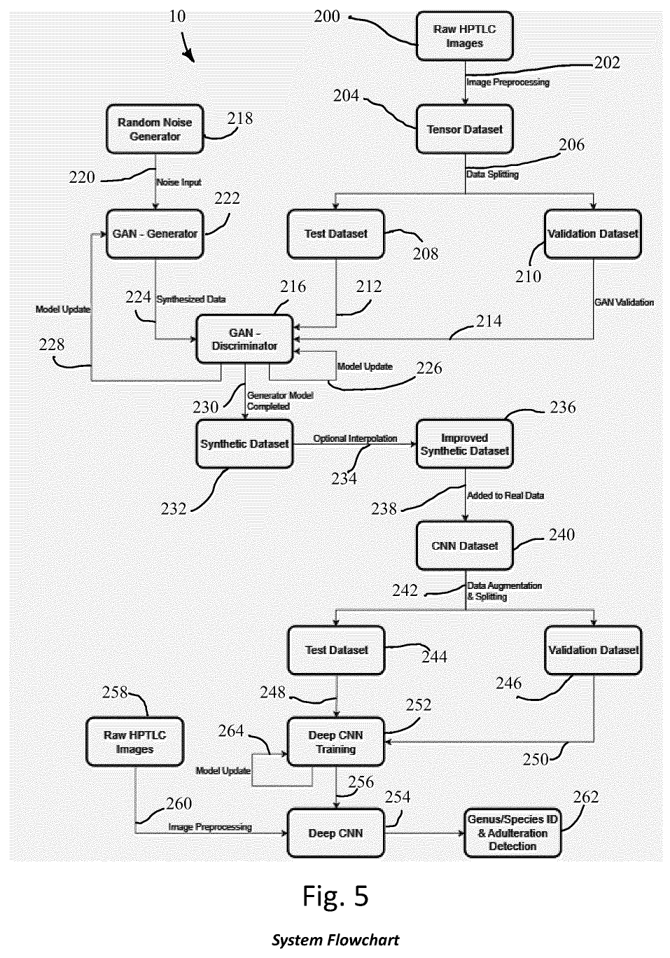

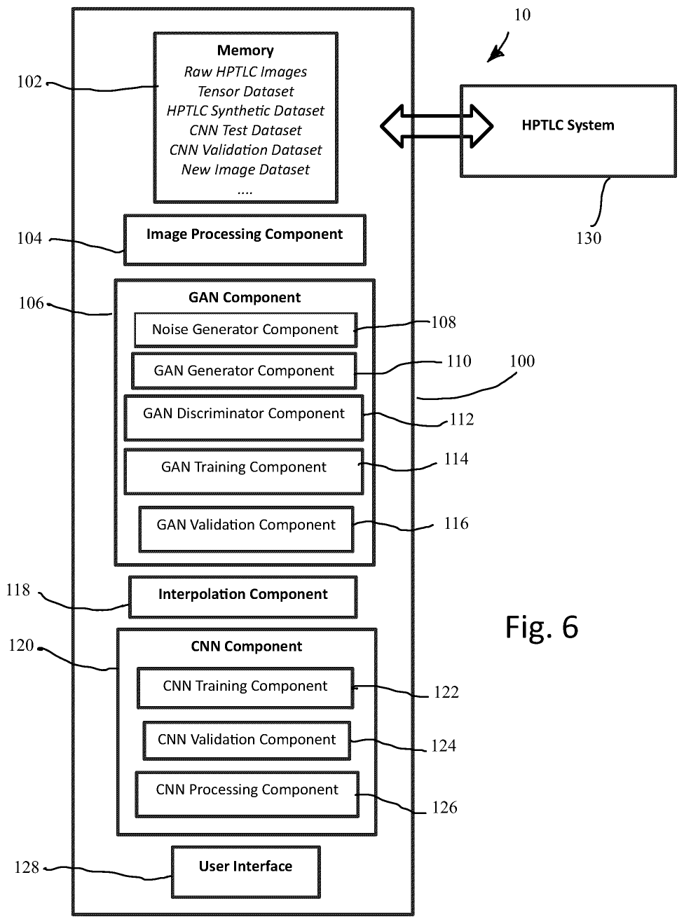

FIG. 5 is a flow chart providing a functional description of the methodology implemented by an embodiment of the present invention. The system 10 receives a plurality of raw HPTLC images in memory as shown at block 200. An example of a single raw HPTLC image is shown in FIG. 1. The raw HPTLC images are processed by an image processing component as represented by arrow 202 to provide an HPTLC tensor dataset at block 204. The HPTLC tensor dataset is split as represented by arrow 206 into a HPTLC test dataset at block 208 and a HPTLC validation dataset at block 210. The HPTLC test dataset and the HPTLC validation dataset are made available as shown by arrows 212 and 214 to the GAN discriminator component at block 216. Within the GAN, a random noise generator component is provided at block 218. As illustrated by arrow 220, the noise generator component provides noise input to the GAN generator component at block 222. The GAN generator component generates synthetic HPTLC data in accordance with the HPTLC GAN generator machine learning model and, as represented by arrow 224, provides the synthetic HPTLC data to the GAN discriminator component at block 216. The GAN discriminator component evaluates the synthetic HPTLC data in accordance with the HPTLC GAN discriminator machine learning model to determine whether the synthetic HPTLC data appears to be real or synthetic. Based on the results of this evaluation, the HPTLC GAN generator ML model and the HPTLC GAN discriminator ML model are updated as appropriate by a GAN training component as represented by arrows 226 and 228. The process of generating and evaluating synthetic data, and updating the ML models is repeated for a set number of iterations or until sufficiently optimized. Once the iterative process has completed, the ML models are validated by a GAN validation component (not shown separately in FIG. 6) against the validation dataset. Upon validation, the GAN models are completed as represented by arrow 230.

The trained and validated GAN is then used to generate the desired number of synthetic images to build the synthetic dataset at block 232. If desired, optional interpolation of the synthetic dataset can be performed by an interpolation component as represented by arrow 234 to build a supplemental synthetic dataset as represented by block 236. In this embodiment, the supplemental synthetic dataset is optionally combined with the real data as represented by arrow 238 to obtain the full CNN dataset at block 240.

If desired, the CNN dataset may be augmented as represented by arrow 242. The CNN dataset (including any augmentation) is split into a test dataset at block 244 and a validation dataset at block 246. As represented by arrows 248 and 250, the test dataset and the validation dataset are made available to the CNN training component at block 252. The CNN training component implements an iterative process represented by arrow 264 in which the HPTLC CNN machine learning model is trained on the test dataset for a specific number of iterations or until the model is sufficiently optimized. The HPTLC CNN machine learning model is validated against the validation dataset. In this illustrated embodiment, validation occurs at block 252, but the validation step may alternatively be represented by a separate functional block (not shown). Once validated, the HPTLC CNN machine learning model is provided to the CNN processing component at block 254 as represented by arrow 256. At this point, the CNN processing component is ready for use in evaluating new HPTLC images. New raw HPTLC images from target samples are stored in memory at block 258. The raw images undergo image processing and the processed images are passed to the CNN processing component as represented by arrow 260. The CNN processing component analyzes each new image to determine the botanical content and to detect any adulterants in the target sample. The results of the analysis are output at block 262. For example, the system may output on a user interface the genus/species identified along with any detected adulterants. The output may include probability determinations associated with the genus/species identification and the adulterant detection.

It should be understood that FIG. 5 represents an exemplary implementation in which various functions and components of the illustrated embodiment are represented by functional blocks and transition arrows that represent functions or operational flow through the system. The present invention may be implemented in a wide range of alternative embodiments. For example, the various features and functions of the system may, in alternative embodiments, be carried out in different sequences or with different functional characterizations. In some alternative applications, certain functions may not be implemented and the corresponding functional black may be eliminated. In some alternative applications, separate functional blocks from the illustrated embodiment may be merged, or individual functional block may be broken out into sub-functional blocks.

FIG. 6 is a schematic representation of one embodiment of the present invention in which the system 10 is described as discrete functional blocks. It should be understood that the different functional blocks need not be physically or otherwise separate from one another, but may instead be implemented in shared software on shared hardware. Further, none of the illustrated functional blocks needs to be implemented in a single segment of software using a single piece of hardware, but may be implemented by various and potentially separate software and hardware components that work in concert with one another to implement the functions associated such functional block. Referring now to FIG. 6, the system 10 generally includes one or more computer systems or subsystems 100 that include the hardware and software used to implement the present invention. The system 10 includes memory 102 that may be used to store, among other things, the raw HPTLC images, the tensor dataset, the HPTLF synthetic dataset, the CNN test dataset, the CNN validation dataset, new raw image data and essentially all other software and associated data embodying the system 10. To prepare of raw HPTLC data for use by the system 10, the system 10 also includes an image processing component 104, which may perform essentially any desired image processing, such as resizing/rescaling, cropping or padding, normalization, color space conversion, filtering and denoising, histogram equalization, channel standardization and/or processing of missing data. A variety of conventional image processing algorithms are known and readily available for use in the present invention. As noted above, the system 10 includes a GAN component 106 that at a high level is configured to generate synthetic HPTLC data. The GAN component 106 generally includes a noise generator component 108, a GAN generator component 110, a GAN discriminator component 112, a GAN training component 114 and a GAN validation component 116. The functions of these various components are described elsewhere herein. In some implementations, the system 10 may also include an interpolation component 118 that generates supplemental synthetic HPTLC data. Referring again to FIG. 6, the illustrated embodiment also includes a CNN component 120 generally including a CNN training component 122, a CNN validation component 124 and a CNN processing component 126. The functions of these components are described elsewhere herein. Further, in the illustrated embodiment, the system 10 includes a user interface 128 that is configured to receive input, such as HPTLC target images, and provide output, such as the system's identification and adulteration determinations.

The system 10 may also be characterized as including an HPTLC system 130 capable of implementing high-performance thin-layer chromatography through which compounds in a target sample can be separated over an HPTLC plate. With colorless compounds, the HPTLC plate may be viewed or photographed under UV-light or it may be stained. A variety of HPTLC systems are well-known and will therefore not be described in detail herein. In the illustrated embodiment, an image of the HPTLC plate is obtained using a camera, scanning densitometer, or other image capture. The captured image is provided as an input to the system 10. The HPTLC system 130 may be used to generate real world data that is used during training of the GAN component and the CNN component, and/or it can be used to obtain new raw images that are processed by the trained and validated CNN operating component.

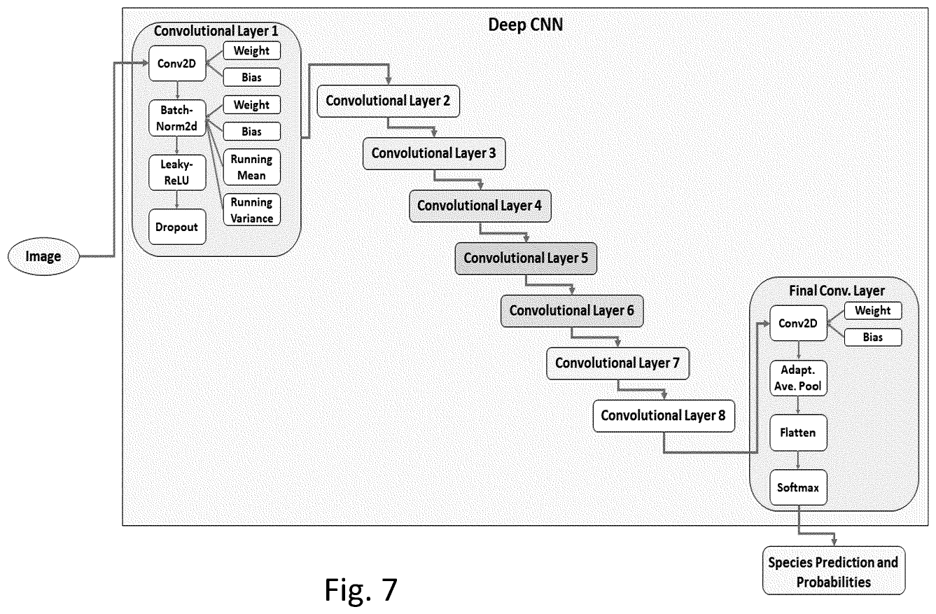

FIG. 7 is a diagram showing the generalized architecture of the CNN used in creating the learned CNN machine-vision model. This diagram is merely exemplary and the present invention may be implemented using an alternative generalized architecture.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A botanical identification and adulteration detection system for use with output images from High-performance Thin-Layer Chromatography (HPTLC), the system comprising:
memory storing a plurality of raw HPTLC images and associated labels, the associated labels including one or more botanical material labels and one or more adulterant labels;
one or more computer subsystems; and
one or more components executed by the one or more computer subsystems, wherein the one or more components include:
an image processing component configured to convert the raw HPTLC images into a tensor dataset, including a GAN test dataset and a GAN validation dataset, each of the GAN test dataset and the GAN validation dataset including a plurality of HPTLC features;
a generative adversarial network (GAN) component configured to generate a synthetic dataset, the GAN component including:
a noise generator component configured to generate noise;
a GAN generator component configured to produce HPTLC synthetic data as a function of an HPTLC GAN generator machine learning model and the noise generated by the noise generator;
a GAN discriminator component configured to evaluate synthetic data produced by the GAN generator as a function of the HPTLC GAN discriminator machine learning model and the GAN test dataset;
a GAN training component configured to train the HPTLC GAN generator machine learning model and the HPTLC GAN discriminator machine learning model based on the evaluation; and
a GAN validation component configured to validate the HPTLC GAN generator machine learning model and the HPTLC GAN discriminator machine learning model against the GAN validation dataset;
memory storing a synthetic dataset containing synthetic data generated by the GAN component using the validated HPTLC machine learning GAN model;
a convolutional neural network (CNN) training component configured to receive a CNN test dataset and a CNN validation dataset, each of the CNN test dataset and the CNN validation dataset including at least a portion of the synthetic dataset and/or at least a portion of the tensor dataset, the CNN training component configured to train an HPTLC CNN machine learning model as a function of the CNN test dataset, the CNN training component includes a CNN validation component configured to validate the HPTLC CNN machine learning model as a function of the CNN validation dataset; and
a CNN processing component configured to receive a new image dataset representing an HPTLC image, and to process the new image dataset to identify botanical material associated with one or more of the botanical labels and to detect adulterants associated with one or more of the adulterant labels using the validated HPTLC CNN machine learning model.

2. The botanical identification and adulteration detection system of claim 1 further including a user interface configured to output the results of the CNN processing component.

3. The botanical identification and adulteration detection system of claim 1 wherein the user interface is configured to output at least one of a genus and a species.

4. The botanical identification and adulteration detection system of claim 3 wherein the user interface is configured to output at least one probability determination of that at least one of a genus and a species.

5. The botanical identification and adulteration detection system of claim 1 wherein the one or more computer subsystems include an interpolation component to generate supplemental synthetic data using an interpolation algorithm.

6. The botanical identification and adulteration detection system of claim 1 wherein the test dataset includes multi-channel data representing red, green and blue pixel data.

7. The botanical identification and adulteration detection system of claim 6 wherein the test dataset includes multi-channel data with values 0 to 255 for each of the red, green and blue pixel data.

8. The botanical identification and adulteration detection system of claim 1 further including an HPTLC system for producing HPTLC output from a target sample.

9. The botanical identification and adulteration detection system of claim 8 wherein the HPTLC system includes an HPTLC plate.

10. The botanical identification and adulteration detection system of claim 9 wherein the HPTLC system include an image capture device configured to capture images of the HPTLC plate.

11. A method for identifying botanical content and detecting adulteration based on output images from High-performance Thin-Layer Chromatography (HPTLC), the method including the steps of:
storing in memory a plurality of raw HPTLC images and associated labels, the associated labels including one or more botanical material labels and one or more adulterant labels;
processing, with an image processing component implemented in a computer, the plurality of raw HPTLC images to provide a tensor dataset, the tensor dataset including a GAN test dataset and a GAN validation dataset, each of the GAN test dataset and the GAN validation dataset including a plurality of HPTLC features;
generating HPTLC synthetic dataset using a generative adversarial network (GAN) component, the generating step including:
generating noise using a noise generator component,
producing, with a GAN generator component, HPTLC synthetic data as a function of an HPTLC GAN generator machine learning model and the noise generated by the noise generator,
evaluating, with a GAN discriminator component, the synthetic data produced by the GAN generator as a function of the HPTLC GAN discriminator machine learning model and the GAN test dataset,
training, with a GAN training component, the HPTLC GAN generator machine learning model and the HPTLC GAN discriminator machine learning model based on the step of evaluating; and
validating, with a GAN validation component, the HPTLC GAN generator machine learning model and the HPTLC GAN discriminator machine learning model against the GAN validation dataset;
generating and storing in memory a synthetic dataset containing synthetic data generated by the GAN component using the validated HPTLC machine learning GAN model;
training, with a convolutional neural network (CNN) component, a CNN using a CNN test dataset, the CNN test dataset including at least a portion of the synthetic dataset and/or at least a portion of the tensor dataset, the CNN training component configured to train an HPTLC CNN machine learning model as a function of the CNN test dataset;
validating, with a CNN validation component, the HPTLC CNN machine learning model as a function of a CNN validation dataset, the CNN test dataset including at least a portion of the synthetic dataset and at least a portion of the tensor dataset; and
processing, with a CNN processing component, a new image dataset representing an HPTLC image to identify botanical material associated with one or more of the botanical labels and to detect adulterants associated with one or more of the adulterant labels using the validated HPTLC CNN machine learning model.

12. The method of claim 11 further including the step of outputting at least one of a genus and a species of a botanical material identified in the processing step.

13. The method of claim 12 wherein the step of outputting further includes outputting a probability associated the identified botanical material.

14. The method of claim 11 wherein the step of storing in memory a plurality of raw HPTLC images and associated labels includes storing in memory a plurality of raw HPTLC images and associated labels of a single target botanical and a plurality of HPTLC images and associated labels of a plurality of common adulterants associated with the single target species.

15. The method of claim 11 wherein the step of storing in memory a plurality of raw HPTLC images and associated labels includes storing in memory a plurality of raw HPTLC images and associated labels of Zingiber offinicale and a plurality of HPTLC images and associated labels of at least two of the following adulterants: Alpinia officinarum, Boesenbergia rotunda, Kaempferia galanga, Kaempferia parviflora, Zingiber montanum and Zingiber zerumbet.

16. The method of claim 11 further including the steps of:
generating, with an interpolation component, supplemental synthetic data using an interpolation algorithm; and
combining the supplemental synthetic data with the synthetic dataset, whereby the supplemental synthetic data becomes part of at least one of the CNN test dataset or the CNN validation dataset.

17. The method of claim 11 wherein the test dataset include multi-channel data representing red, green and blue pixel data.

18. The method of claim 11 wherein the test dataset includes multi-channel data with values 0 to 255 for each of the red, green and blue pixel data.

19. The method of claim 11 further including the step of preforming HPTLC on a target sample to obtain an HPTLC plate.

20. The method of claim 19 further including the step of capturing an image of the HPTLC plate; and
at least one of the following:
providing the captured image as a raw HPTLC image to become part of the tensor dataset; and
providing the captured image as a new image dataset to the CNN processing component.
